(19) United States
(12) Patent Application Publication
(10) Pub. No.: US 2026/0113220 A1
(43) Pub. Date: Apr. 23, 2026

(54) DECISION FEEDBACK EQUALIZER AND MEMORY DEVICE INCLUDING THE SAME

(71) Applicant: SAMSUNG ELECTRONICS CO., LTD., Suwon-si (KR)

(72) Inventor: WANGSOO KIM, Suwon-si (KR)

(73) Assignee: SAMSUNG ELECTRONICS CO., LTD., Suwon-si (KR)

(21) Appl. No.: 19/354,232

(22) Filed: Oct. 9, 2025

(30) Foreign Application Priority Data
Jan. 17, 2025 (KR) 10-2025-0007624
Oct. 18, 2024 (KR) 10-2024-0143216

(51) Int. Cl. H04L 25/03

(52) U.S. Cl. CPC H04L 25/03057

(57) ABSTRACT

A semiconductor device includes a data pad and a decision feedback equalizer configured to equalize a data signal received through the data pad. The decision feedback equalizer may include a plurality of decision feedback equalization blocks, respectively corresponding to a plurality of clock signals having different phases. Each of the plurality of decision feedback equalization blocks may include an input stage configured to compare a reference voltage with the data signal based on a corresponding clock signal, and amplify a difference between the reference voltage and a voltage of the data signal, and generate a first feedback signal and a second feedback signal based on the amplified difference between the reference voltage and the voltage of the data signal. and a latching stage configured to generate a first output signal and a second output signal based on a difference between the first feedback signal and the second feedback signal.

### CROSS-REFERENCE TO RELATED APPLICATIONS

This U.S. non-provisional application claims priority under 35 USC § 119 to Korean Patent Application Nos. 10-2024-0143216, filed on October 18, 2024 and 10-2025-0007624, filed on January 17, 2025, in the Korean Intellectual Property Office, the disclosures of which are herein incorporated by reference in their entirety.

### BACKGROUND

The present disclosure relates to a decision feedback equalizer and a memory device including the same.

In a memory system, a host and a memory device are connected through a transmission line (or a communication channel), and data signals may be exchanged between the host and the memory device through the transmission line. A data signal received by the memory device may be distorted due to inter-symbol interference (ISI) caused by noise arising from the characteristics of the transmission line or limitations in the bandwidth of the transmission line.

For example, as a data rate increases to achieve higher data throughput, a data signal transmitted through a transmission line becomes more susceptible to inter-symbol interference and the quality of the data signal received by a memory device may further degrade. A decision feedback equalizer (DFE) may be used to mitigate the effects of the inter-symbol interference.

### SUMMARY

The present disclosure provides a decision feedback equalizer with improved performance and a memory device including the same.

In one or more embodiments of the present disclosure, a semiconductor device may include: a data pad; and a decision feedback equalizer configured to equalize a data signal received through the data pad. The decision feedback equalizer may include a plurality of decision feedback equalization blocks, respectively corresponding to a plurality of clock signals having different phases. Each of the plurality of decision feedback equalization blocks may include: an input stage configured to compare a reference voltage with the data signal based on a corresponding clock signal, and amplify a difference between the reference voltage and a voltage of the data signal, and generate a first feedback signal and a second feedback signal based on the amplified difference between the reference voltage and the voltage of the data signal; and a latching stage configured to generate a first output signal and a second output signal based on a difference between the first feedback signal and the second feedback signal.

In one or more embodiments of the present disclosure, a decision feedback equalizer may include: a first decision feedback equalization block configured to operate based on a first clock signal; a second decision feedback equalization block configured to operate based on a second clock signal that is phase-shifted by 90 degrees relative to the first clock signal; a third decision feedback equalization block configured to operate based on a third clock signal that is phase-shifted by 180 degrees relative to the first clock signal; and a fourth decision feedback equalization block configured to operate based on a fourth clock signal that may be phase-shifted by 270 degrees relative to the first clock signal. Each of the first to fourth decision feedback equalization blocks may include: an input stage configured to compare a reference voltage with a data signal based on a corresponding clock signal, amplify a difference between the reference voltage and the data signal, and generate a first feedback signal and a second feedback signal based on the amplified difference between the reference voltage and the data signal; and a latching stage configured to generate a first output signal and a second output signal based on a difference between the first feedback signal and the second feedback signal.

In one or more embodiments of the present disclosure, a decision feedback equalizer may include: an input stage configured to compare a reference voltage with a data signal based on a first clock signal and generate a first feedback signal and a second feedback signal based on a comparison between the reference voltage and the data signal; and a latching stage configured to latch a difference between the first feedback signal and the second feedback signal and generate a first output signal and a second output signal. The input stage may include a source degeneration circuit configured to apply a gain in a predetermined frequency band greater than a threshold frequency, to a difference between the reference voltage and a voltage of the data signal.

### BRIEF DESCRIPTION OF DRAWINGS

FIG. 1 is a block diagram of a memory device according to one or more embodiments.

FIG. 2 is a block diagram of a memory device according to one or more embodiments.

FIG. 3A is a circuit diagram of a decision feedback equalization block according to one or more embodiments.

FIG. 3B is a circuit diagram of a latch block according to one or more embodiments.

FIG. 4A is a circuit diagram of a decision feedback equalization block according to one or more embodiments.

FIG. 4B is a circuit diagram of a latch block according to one or more embodiments.

FIG. 5A is a circuit diagram of a decision feedback equalization block according to one or more embodiments.

FIG. 5B is a circuit diagram of a latch block according to one or more embodiments.

FIG. 6A is a circuit diagram of a decision feedback equalization block according to one or more embodiments.

FIG. 6B is a circuit diagram of a latch block according to one or more embodiments.

FIG. 7 is a timing diagram illustrating signals of a decision feedback equalization block and a latch block according to one or more embodiments.

FIG. 8 is an exemplary diagram illustrating, in greater detail, a portion of driving signals of a decision feedback equalization block according to one or more embodiments.

FIG. 9 is a diagram illustrating the effect of a source degeneration circuit according to one or more embodiments.

FIG. 10A is a diagram illustrating the effect of a decision feedback equalizer according to one or more embodiments.

FIG. 10B is a diagram illustrating the effect of a decision feedback equalizer according to one or more embodiments.

FIG. 10C is a diagram illustrating the effect of a decision feedback equalizer according to one or more embodiments.

FIG. 11 is a block diagram of a memory device according to one or more embodiments.

### DETAILED DESCRIPTION

The following description with reference to the accompanying drawings is provided to assist in a comprehensive understanding of various embodiments of the present disclosure.

The term “first,” “second,” or the like, used herein may modify various elements regardless of the order and/or priority thereof, and is used only for distinguishing one element from another element, without limiting embodiments.

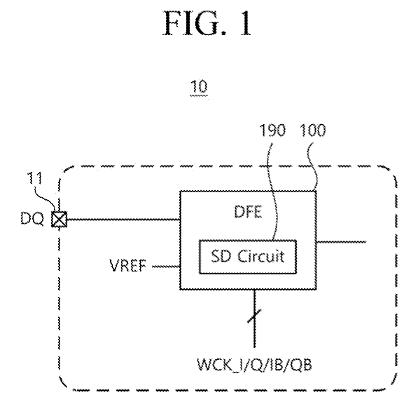

FIG. 1 is a block diagram of a memory device according to one or more embodiments. A memory device 10 according to one or more embodiments may include a decision feedback equalizer (DFE) 100 configured to equalize a data signal DQ. The decision feedback equalizer 100 may include a source degeneration (SD) circuit 190 configured to apply or provide a high-frequency gain to a difference between a voltage of a data signal DQ and a reference voltage VREF.

Compared to a case without the source degeneration circuit 190, when the voltage difference between the voltage of the data signal DQ and the reference voltage VREF includes a relatively high proportion of high-frequency components, for example, when a data value included in the data signal DQ transitions from a logic high to low or from a logic low to high, the effect of inter-symbol interference (hereinafter referred to as “ISI”) may be further reduced. Accordingly, the decision feedback equalizer 100 may equalize the data signal DQ with improved performance, enhancing the data reception performance of the memory device 10.

This will be described in greater detail with reference to FIG. 1. The memory device 10 may include a data pad 11 and a decision feedback equalizer (DFE) 100.

The data pad 11 may receive the data signal DQ. The data signal DQ may be transmitted from a host through a transmission line. The data pad 11 may also be referred to as a data pin.

The decision feedback equalizer 100 may equalize the data signal DQ received through the data pad 11.

To this end, according to one or more embodiments, the decision feedback equalizer 100 may include a plurality of decision feedback equalization blocks, respectively corresponding to a plurality of clock signals (e.g., WCK_I, WCK_Q, WCK_IB, and WCK_QB) having different phases. Among the plurality of clock signals, WCK_Q may be phase-shifted by 90 degrees relative to WCK_I, which may correspond to a quarter-period delay at the operating frequency. WCK_IB may be phase-shifted by 180 degrees relative to WCK_I, which may correspond to a half-period delay at the operating frequency. WCK_QB may be phase-shifted by 270 degrees relative to WCK_I, which may correspond to a three-quarter-period delay at the operating frequency.

According to one or more embodiments, each of the plurality of decision feedback equalization blocks may include an input stage and a latching stage.

The input stage may compare the reference voltage VREF with the data signal DQ in synchronization with its corresponding clock signal to generate a first feedback signal and a second feedback signal. The first feedback signal and the second feedback signal may form a pair of differential feedback signals generated based on the comparison between the data signal DQ and the reference voltage VREF, and may represent the positive and negative sides of the comparison.

The source degeneration circuit 190 may be included in the input stage of each of the plurality of decision feedback equalization blocks. The source degeneration circuit 190 may function as a frequency-selective amplifier, such as a high-pass amplifier or a high-pass filter, configured to apply a high-frequency gain to the difference between the voltage of the data signal DQ and the reference voltage VREF. The source degeneration circuit 190 may amplify components of the input signal, specifically the high-frequency components of the differential input (DQ − VREF). Here, the term “high-frequency gain” may refer to a gain applied within a predetermined frequency band that is greater than a predetermined threshold frequency. When the difference between the voltage of the data signal DQ and the reference voltage VREF includes a relatively high proportion of high-frequency components, a difference between the first feedback signal and the second feedback signal may increase by the amount of the high-frequency gain applied by the source degeneration circuit 190.

The latching stage may generate a first output signal and a second output signal based on the difference between the first feedback signal and the second feedback signal. For example, the latching stage may latch the difference between the first feedback signal and the second feedback signal to generate the first output signal and the second output signal.

The data value included in the data signal DQ may be recovered or reconstructed based on the latched output signals (i.e., the first output signal and the second output signal), as described below. Therefore, the precision of the reconstruction depends on the differential magnitude between the first and second feedback signals, such that and the greater the difference between the first feedback signal and the second feedback signal, the more accurately the latching stage may latch the difference, which results in more accurate data recovery.

According to one or more embodiments, by increasing the difference between the first feedback signal and the second feedback signal through the high-frequency gain provided by the source degeneration circuit 190, the decision feedback equalizer 100 may equalize the data signal DQ with improved performance.

An example has been described, where a write clock signal WCK is used as the plurality of clock signals, respectively corresponding to the plurality of decision feedback equalization blocks. However, embodiments are not limited thereto. According to one or more embodiments, a data strobe signal DQS may be used as the plurality of clock signals, respectively corresponding to the plurality of decision feedback equalization blocks. For clarity, a description will be provided using the write clock signal WCK as an example.

The memory device 10 may include a memory cell array including a plurality of memory cells. The memory device 10 may store data, recovered based on the output signals of the decision feedback equalizer 100, in the memory cell array. In addition, the memory device 10 may read data stored in the memory cell array in response to a request from the host and transmit the read data to the host through the data pad 11.

According to one or more embodiments, the memory device 10 may include volatile memory cells. For example, the memory device 200 may include one or more of various DRAM devices such as a double data rate synchronous dynamic random access memory (DDR SDRAM) device, a DDR2 SDRAM device, a DDR3 SDRAM device, a DDR4 SDRAM device, a DDR5 SDRAM device, a DDR6 SDRAM device, a low power double data rate (LPDDR) SDRAM device, an LPDDR2 SDRAM device, an LPDDR3 SDRAM device, an LPDDR4 SDRAM device, an LPDDR4X SDRAM device, an LPDDR5 SDRAM device, a graphics double data rate synchronous graphics random access memory (GDDR SGRAM) device, a GDDR2 SGRAM device, a GDDR3 SGRAM device, a GDDR4 SGRAM device, a GDDR5 SGRAM device, or a GDDR6 SGRAM device.

According to one or more embodiments, the memory device 10 may be a stacked memory device in which DRAM dies are stacked, such as a high bandwidth memory (HBM) device, an HBM2 device, or an HBM3 device.

According to one or more embodiments, the memory device 10 may be a memory module such as a dual in-line memory module (DIMM). For example, the memory module 100A may be a registered DIMM (RDIMM), a load reduced DIMM (LRDIMM0, an unbuffered DIMM (UDIMM), a fully buffered DIMM (FB-DIMM), a small outline DIMM (SO-DIMM). However, this is only an example, and the memory device 200 may be another memory module such as a single in-line memory module (SIMM).

According to one or more embodiments, the memory device 10 may be an SRAM device, a NAND flash memory device, a NOR flash memory device, an RRAM device, an FRAM device, a PRAM device, a TRAM device, or an MRAM device.

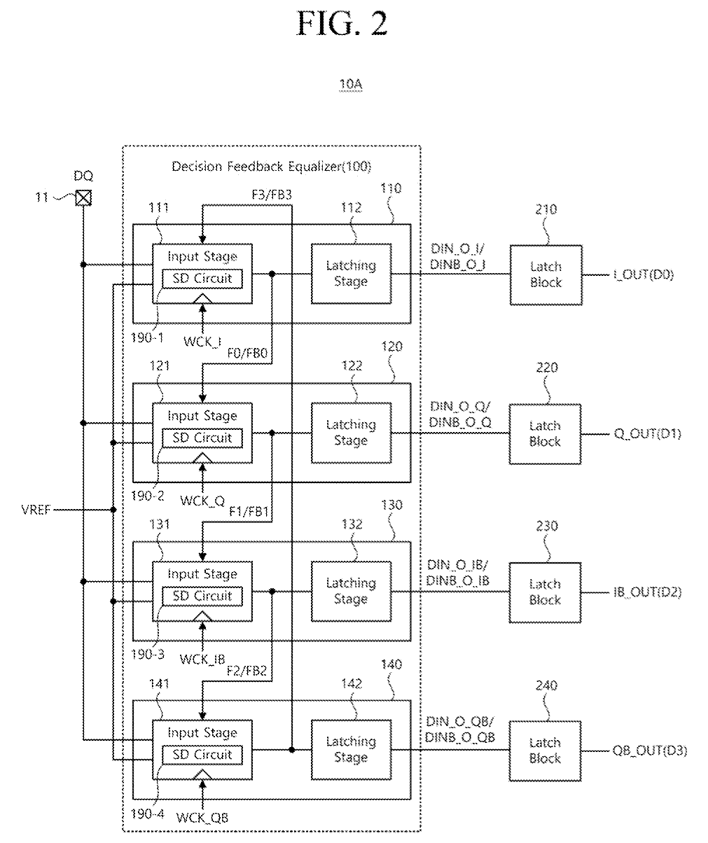

FIG. 2 is a block diagram of a memory device according to one or more embodiments. A memory device 10A of FIG. 2 may be an example of the memory device 10 of FIG. 1, but embodiments are not limited thereto.

Referring to FIG. 2, the memory device 10A may include a data pad 11, a decision feedback equalizer 100, and a plurality of latch blocks 210, 220, 230, and 240.

The decision feedback equalizer 100 may include a plurality of decision feedback equalization blocks. For example, the decision feedback equalizer 100 may include a first decision feedback equalization block 110, a second decision feedback equalization block 120, a third decision feedback equalization block 130, and a fourth decision feedback equalization block 140.

The first decision feedback equalization block 110 may include a first input stage 111 and a first latching stage 112.

The first input stage 111 may include a first source degeneration circuit 190-1. The first input stage 111 may compare a reference voltage VREF with a data signal DQ based on a first clock signal WCK_I to generate a first feedback signal F0 and a second feedback signal FB0.

The first latching stage 112 may receive the first feedback signal F0 and the second feedback signal FB0 from the first input stage 111 and generate a first output signal DIN_O_I and a second output signal DINB_O_I based on a difference between the first feedback signal F0 and the second feedback signal FB0.

The second decision feedback equalization block 120 may include a second input stage 121 and a second latching stage 122.

The second input stage 121 may include a second source degeneration circuit 190-2. The second input stage 121 may compare the reference voltage VREF with the data signal DQ based on a second clock signal WCK_Q to generate a third feedback signal F1 and a fourth feedback signal FB1.

The second latching stage 122 may receive the third feedback signal F1 and the fourth feedback signal FB1 from the second input stage 121 and generate a third output signal DIN_O_Q and a fourth output signal DINB_O_Q based on a difference between the third feedback signal F1 and the fourth feedback signal FB1.

The third decision feedback equalization block 130 may include a third input stage 131 and a third latching stage 132.

The third input stage 131 may include a third source degeneration circuit 190-3. The third input stage 131 may compare the reference voltage VREF with the data signal DQ based on a third clock signal WCK_IB to generate a fifth feedback signal F2 and a sixth feedback signal FB2.

The third latching stage 132 may receive the fifth feedback signal F2 and the sixth feedback signal FB2 from the third input stage 131 and generate a fifth output signal DIN_O_IB and a sixth output signal DINB_O_IB based on a difference between the fifth feedback signal F2 and the sixth feedback signal FB2.

The fourth decision feedback equalization block 140 may include a fourth input stage 141 and a fourth latching stage 142.

The fourth input stage 141 may include a fourth source degeneration circuit 190-4. The fourth input stage 141 may compare the reference voltage VREF with the data signal DQ based on a fourth clock signal WCK_QB to generate a seventh feedback signal F3 and an eighth feedback signal FB3.

The fourth latching stage 142 may receive the seventh feedback signal F3 and the eighth feedback signal FB3 from the fourth input stage 141 and generate a seventh output signal DIN_O_QB and an eighth output signal DINB_O_QB based on a difference between the seventh feedback signal F3 and the eighth feedback signal FB3.

According to one or more embodiments, the pair of feedback signals F0 and FB0, the pair of feedback signals F1 and FB1, the pair of feedback signals F2 andFB2, and the pair of feedback signals F3 and FB3, respectively generated by the first to fourth input stages 111, 121, 131, and 141 of the first to fourth decision feedback equalization blocks 110, 120, 130, and 140, may be fed back to an input stage of another decision feedback equalization block.

For example, the first and second feedback signals F0 and FB0 generated by the first input stage 111 of the first decision feedback equalization block 110 may be fed back to the second input stage 121 of the second decision feedback equalization block 120.

In addition, the third and fourth feedback signals F1 and FB1 generated by the second input stage 121 of the second decision feedback equalization block 120 may be fed back to the third input stage 131 of the third decision feedback equalization block 130.

In addition, the fifth and sixth feedback signals F2 and FB2 generated by the third input stage 131 of the third decision feedback equalization block 130 may be fed back to the fourth input stage 141 of the fourth decision feedback equalization block 140.

In addition, the seventh and eighth feedback signals F3 and FB3 generated by the fourth input stage 141 of the fourth decision feedback equalization block 140 may be fed back to the first input stage 111 of the first decision feedback equalization block 110.

Each decision feedback equalization block receives feedback signals from a single other decision feedback equalization block, so that the decision feedback equalizer 100 may be considered a one-tap decision feedback equalizer.

The plurality of latch blocks 210, 220, 230, and 240 may correspond to the plurality of decision feedback equalization blocks 110, 120, 130, and 140, respectively. Each of the plurality of latch blocks 210, 220, 230, and 240 may output data included in the data signal DQ based on an output signal output from a corresponding decision feedback equalization block.

For example, the first latch block 210 corresponding to the first decision feedback equalization block 110 may output first data D0 included in the data signal DQ based on first and second output signals DIN_O_I and DINB_O_I output from the first latching stage 112. The output signal I_OUT of the first latch block 210 may correspond to the first data D0.

In addition, the second latch block 220 corresponding to the second decision feedback equalization block 120 may output second data D1 included in the data signal DQ based on third and fourth output signals DIN_O_Q and DINB_O_Q output from the second latching stage 122. The output signal Q_OUT of the second latch block 220 may correspond to the second data D1.

In addition, the third latch block 230 corresponding to the third decision feedback equalization block 130 may output third data D2 included in the data signal DQ based on fifth and sixth output signals DIN_O_IB and DINB_O_IB output from the third latching stage 132. The output signal IB_OUT of the third latch block 230 may correspond to the third data D2.

In addition, the fourth latch block 240 corresponding to the fourth decision feedback equalization block 140 may output fourth data D3 included in the data signal DQ based on seventh and eighth output signals DIN_O_QB and DINB_O_QB output from the fourth latching stage 142. The output signal QB_OUT of the fourth latch block 240 may correspond to the fourth data D3.

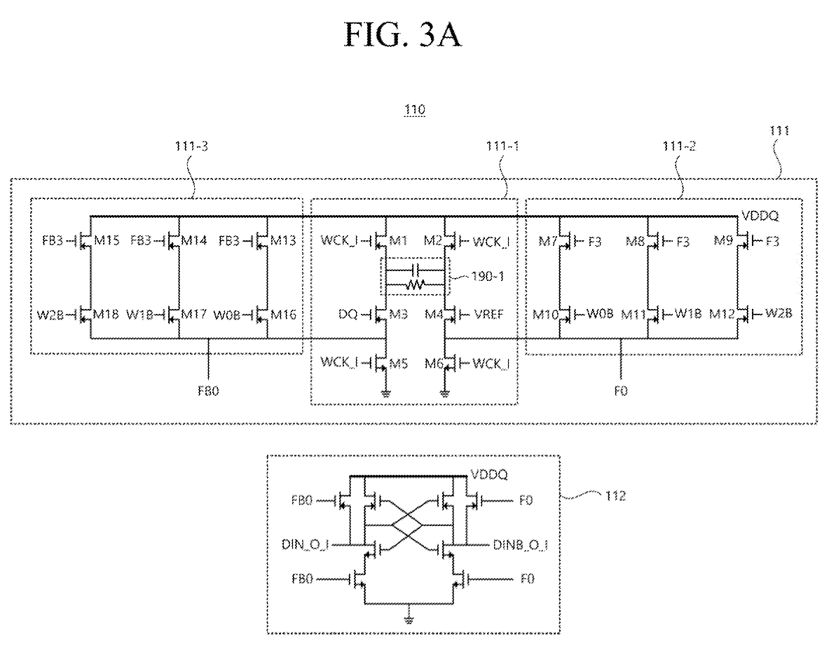

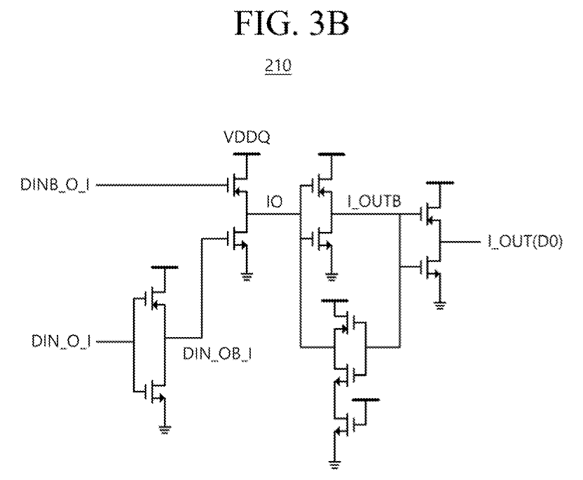

Hereinafter, the decision feedback equalization block and the latch block according to one or more embodiments are described in greater detail with reference to FIGS. 3A-6B.

FIG. 3A is a circuit diagram of a decision feedback equalization block according to one or more embodiments. A decision feedback equalization block 110 of FIG. 3A may correspond to the first decision feedback equalization block 110 of FIG. 2.

Referring to FIG. 3A, the first decision feedback equalization block 110 may include a first input stage 111 and a first latching stage 112.

The first input stage 111 may include first input circuitry 111-1 and first tap circuitries 111-2 and 111-3.

The first input circuitry 111-1 may receive a reference voltage VREF, a data signal DQ, and a first clock signal WCK_I.

The first input circuitry 111-1 may compare the reference voltage VREF and the data signal DQ based on the first clock signal WCK_I to generate a first feedback signal F0 and a second feedback signal FB0. The first input circuitry 111-1 may apply a high-frequency gain to a difference between the voltage of the data signal DQ and the reference voltage VREF using the first source degeneration circuit 190-1. Accordingly, when the difference between the voltage of the data signal DQ and the reference voltage VREF includes a relatively high proportion of high-frequency components, a difference between the first feedback signal F0 and the second feedback signal FB0 may increase.

To this end, according to one or more embodiments, the first input circuitry 111-1 may include a first PMOS transistor M1, a second PMOS transistor M2, a third PMOS transistor M3, a fourth PMOS transistor, a first NMOS transistor M5, a second NMOS transistor M6, and a first source degeneration circuit 190-1.

The first PMOS transistor M1 may include a drain terminal connected to a power supply voltage (e.g., VDDQ), a source terminal connected to one end of the first source degeneration circuit 190-1, and a gate terminal to which the first clock signal WCK_I is applied.

The second PMOS transistor M2 may include a drain terminal connected to a power supply voltage, a source terminal connected to the other end of the first source degeneration circuit 190-1, and a gate terminal to which a first clock signal WCK_I is applied.

The third PMOS transistor M3 may include a drain terminal connected to one end of the first source degeneration circuit 190-1, a source terminal through which a second feedback signal FB0 is output, and a gate terminal to which the data signal DQ is applied.

The fourth PMOS transistor M4 may include a drain terminal connected to the other end of the first source degeneration circuit 190-1, a source terminal through which a first feedback signal F0 is output, and a gate terminal to which the reference voltage VREF is applied.

The first NMOS transistor M5 may include a drain terminal connected to the source terminal of the third PMOS transistor M3, a source terminal connected to a ground voltage, and a gate terminal to which a first clock signal WCK_I is applied.

The second NMOS transistor M6 may include a drain terminal connected to the source terminal of the fourth PMOS transistor M4, a source terminal connected to the ground voltage, and a gate terminal to which a first clock signal WCK_I is applied.

The first source degeneration circuit 190-1 may include a capacitor and a resistor connected in parallel, but embodiments are not limited thereto. In one or more embodiments, the first source degeneration circuit 190-1 may include only a capacitor without a resistor. One end of the first source degeneration circuit 190-1 may be commonly connected to the source terminal of the first PMOS transistor M1 and the drain terminal of the third PMOS transistor M3, and the other end of the first source degeneration circuit 190-1 may be commonly connected to the source terminal of the second PMOS transistor M2 and the drain terminal of the fourth PMOS transistor M4.

The first tap circuitries 111-2 and 111-3 may receive the seventh feedback signal F3 and the eighth feedback signal FB3 generated by the fourth decision feedback equalization block 140 and tap coefficients W0B, W1B, and W2B.

The first tap circuitries 111-2 and 111-3 may apply weights to the first feedback signal F0 and the second feedback signal FB0 based on the seventh feedback signal F3 and the eighth feedback signal FB3 and the tap coefficients W0B, W1B, and W2B. Accordingly, a difference between the first feedback signal F0 and the second feedback signal FB0 may increase.

To this end, according to one embodiment, the first tap circuitries 111-2 and 111-3 may include a first tap circuit 111-2 applying a weight to the first feedback signal F0 based on the seventh feedback signal F3 and the tap coefficients W0B, W1B, and W2B. In addition, the first tap circuitries 111-2 and 111-3 may include a second tap circuit 111-3 applying a weight to the second feedback signal FB0 based on the eighth feedback signal FB3 and the tap coefficients W0B, W1B, and W2B.

As described above, the difference between the first feedback signal F0 and the second feedback signal FB0 may be determined based on the difference between the reference voltage VREF and the voltage of the data signal DQ, the tap coefficients W0B, W1B, and W2B, and the high-frequency gain applied by the first source degeneration circuit 190-1.

The first latching stage 112 may generate a first output signal DIN_O_I and a second output signal DINB_O_I based on the first feedback signal F0 and the second feedback signal FB0. For example, the first latching stage 112 may latch the difference between the first feedback signal F0 and the second feedback signal FB0 to generate a first output signal DIN_O_I and a second output signal DINB_O_I.

FIG. 3B is a circuit diagram of a latch block according to one or more embodiments. A latch block 210 of FIG. 3B may correspond to the first latch block 210 of FIG. 2.

Referring to FIG. 3B, the first latch block 210 may output first data D0 included in the data signal DQ based on the first and second output signals DIN_O_I and DINB_O_I generated by the first latching stage 112. An output signal I_OUT of the first latch block 210 may correspond to the first data D0.

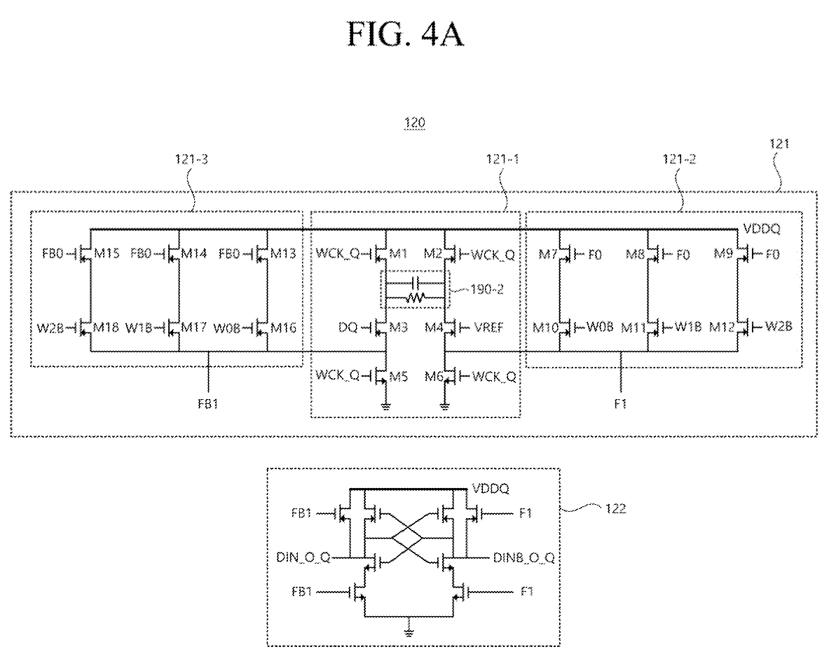

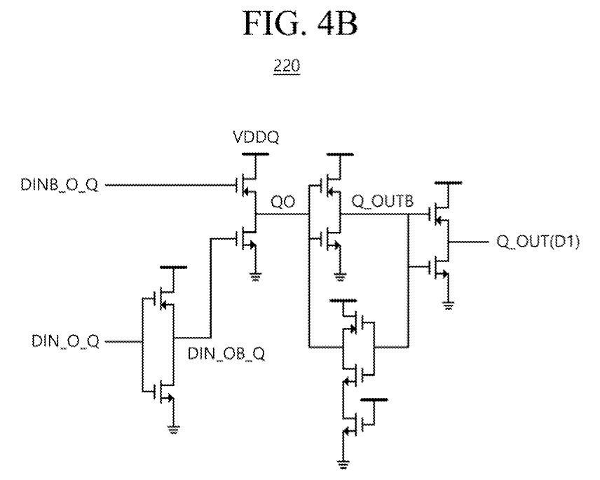

FIG. 4A is a circuit diagram of a decision feedback equalization block according to one or more embodiments. A decision feedback equalization block 120 of FIG. 4A may correspond to the second decision feedback equalization block 120 of FIG. 2.

Referring to FIG. 4A, the second decision feedback equalization block 120 may include a second input stage 121 and a second latching stage 122.

The second input stage 121 may include a second input circuitry 121-1 and a second tap circuitries 121-2 and 121-3.

The second input circuitry 121-1 may receive a reference voltage VREF, a data signal DQ, and a second clock signal WCK_Q.

The second input circuitry 121-1 may compare the reference voltage VREF and the data signal DQ based on the second clock signal WCK_Q to generate a third feedback signal F1 and a fourth feedback signal FB1. The second input circuitry 121-1 may apply a high-frequency gain to a difference between the voltage of the reference voltage VREF and the data signal DQ using the second source degeneration circuit 190-2. Accordingly, when the difference between the voltage of the data signal DQ and the reference voltage VREF includes a relatively high proportion of high-frequency components, a difference between the third feedback signal F1 and the fourth feedback signal FB1 may increase.

The second input circuitry 121-1 may have the same configuration as the first input circuitry 111-1. However, the only difference is that the second clock signal WCK_Q is applied to gate terminals of the first PMOS transistor M1, the second PMOS transistor M2, the first NMOS transistor M5, and the second NMOS transistor M6, so that redundant descriptions are omitted.

The second tap circuitries 121-2 and 121-3 may receive the first feedback signal F0 and the second feedback signal FB0 generated by the first decision feedback equalization block 110 and the tap coefficients W0B, W1B, and W2B.

The second tap circuitries 121-2 and 121-3 may apply weights to the third feedback signal F1 and the fourth feedback signal FB1 based on the first feedback signal F0 and the second feedback signal FB0 and the tap coefficients W0B, W1B, and W2B. Accordingly, a difference between the third feedback signal F1 and the fourth feedback signal FB1 may increase.

To this end, according to one or more embodiments, the second tap circuitries 121-2 and 121-3 may include a third tap circuit 121-2 applying a weight to the third feedback signal F1 based on the first feedback signal F0 and the tap coefficients W0B, W1B, and W2B. In addition, the second tap circuitries 121-2 and 121-3 may include a fourth tap circuit 121-3 applying a weight to the fourth feedback signal FB1 based on the second feedback signal FB0 and the tap coefficients W0B, W1B, and W2B.

As described above, the difference between the third feedback signal F1 and the fourth feedback signal FB1 may be determined based on a difference between the reference voltage VREF and a voltage of the data signal DQ, the tap coefficients W0B, W1B, and W2B, and the high-frequency gain applied by the second source degeneration circuit 190-2.

The second latching stage 122 may latch the difference between the third feedback signal F1 and the fourth feedback signal FB1 to generate a third output signal DIN_O_Q and a fourth output signal DINB_O_Q.

FIG. 4B is a circuit diagram of a latch block according to one or more embodiments. A latch block 220 of FIG. 4B may correspond to the second latch block 220 of FIG. 2.

Referring to FIG. 4B, the second latch block 220 may output second data D1 included in the data signal DQ based on the third and fourth output signals DIN_O_Q and DINB_O_Q generated by the second latching stage 122. The output signal Q_OUT of the second latch block 220 may correspond to the second data D1.

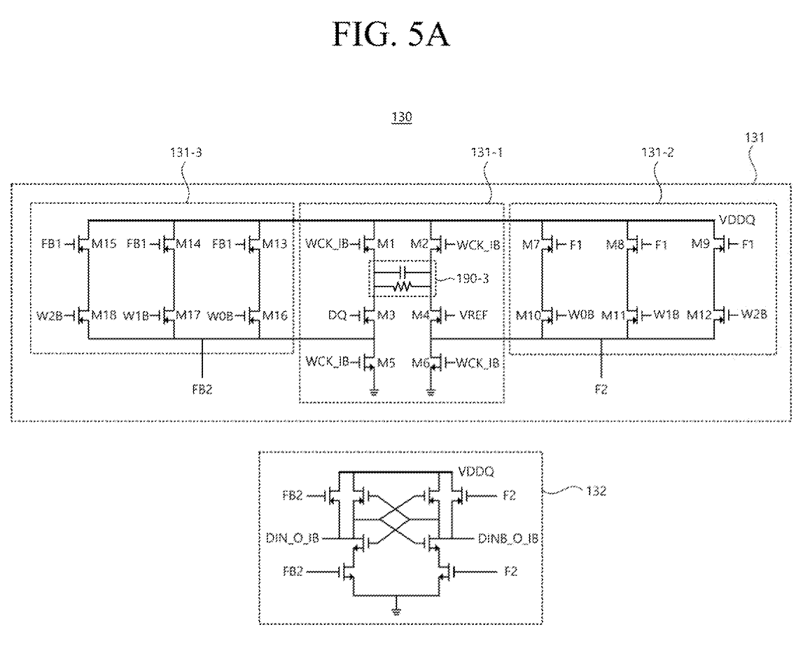

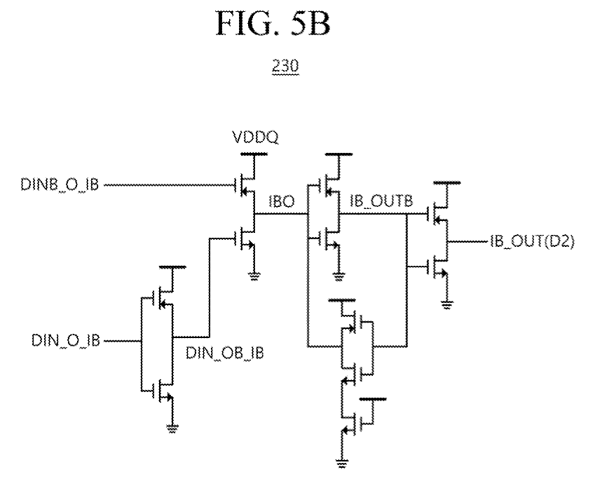

FIG. 5A is a circuit diagram of a decision feedback equalization block according to one or more embodiments. A decision feedback equalization block 130 of FIG. 5A may correspond to the third decision feedback equalization block 130 of FIG. 2.

Referring to FIG. 5A, the third decision feedback equalization block 130 may include a third input stage 131 and a third latching stage 132.

The third input stage 131 may include a third input circuitry 131-1 and a third tap circuitries 131-2 and 131-3.

The third input circuitry 131-1 may receive a reference voltage VREF, a data signal DQ, and a third clock signal WCK_IB.

The third input circuitry 131-1 may compare the reference voltage VREF and the data signal DQ based on the third clock signal WCK_IB to generate a fifth feedback signal F2 and a sixth feedback signal FB2. The third input circuitry 131-1 may apply a high-frequency gain to a difference between the voltage of the reference voltage VREF and the data signal DQ using the third source degeneration circuit 190-3 to. Accordingly, when the difference between the voltage of the data signal DQ and the reference voltage VREF includes a relatively high proportion of high-frequency components, a difference between the fifth feedback signal F2 and the sixth feedback signal FB2 may increase.

The third input circuitry 131-1 may have the same configuration as the first input circuitry 111-1. However, the only difference is that the third clock signal WCK_IB is applied to gate terminals of the first PMOS transistor M1, the second PMOS transistor M2, the first NMOS transistor M5, and the second NMOS transistor M6, so that redundant descriptions are omitted.

The third tap circuitries 131-2 and 131-3 may receive the third feedback signal F1 and the fourth feedback signal FB1 generated by the second decision feedback equalization block 120 and tap coefficients W0B, W1B, and W2B.

The third tap circuitries 131-2 and 131-3 may apply weights to the fifth feedback signal F2 and the sixth feedback signal FB2 based on the third feedback signal F1 and the fourth feedback signal FB1 and the tap coefficients W0B, W1B, and W2B. Accordingly, a difference between the fifth feedback signal F2 and the sixth feedback signal FB2 may increase.

To this end, according to one embodiment, the third tap circuitries 131-2 and 131-3 may include a fifth tap circuit 131-2 applying a weight to the fifth feedback signal F2 based on the third feedback signal F1 and the tap coefficients W0B, W1B, and W2B. In addition, the third tap circuitries 131-2 and 131-3 may include a sixth tap circuit 131-3 applying a weight to the sixth feedback signal FB2 based on the fourth feedback signal FB1 and the tap coefficients W0B, W1B, and W2B.

As described above, the difference between the fifth feedback signal F2 and the sixth feedback signal FB2 may be determined based on the difference between the voltage of the reference voltage VREF and the data signal DQ, the tap coefficients W0B, W1B, and W2B, and the high-frequency gain applied by the third source degeneration circuit 190-3.

The third latching stage 132 may latch the difference between the fifth feedback signal F2 and the sixth feedback signal FB2 to generate a fifth output signal DIN_O_IB and a sixth output signal DINB_O_IB.

FIG. 5B is a circuit diagram of a latch block according to one or more embodiments. A latch block 230 of FIG. 5b may correspond to the third latch block 230 of FIG. 2.

Referring to FIG. 5B, the third latch block 230 may output third data D2 included in the data signal DQ based on the fifth and sixth output signals DIN_O_IB and DINB_O_IB generated by the third latching stage 132. The output signal IB_OUT of the third latch block 230 may correspond to the third data D2.

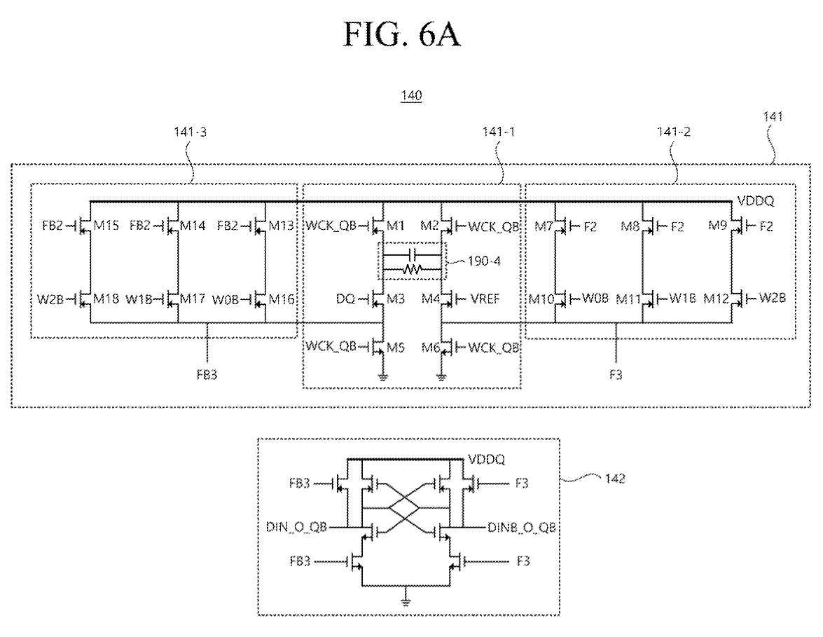

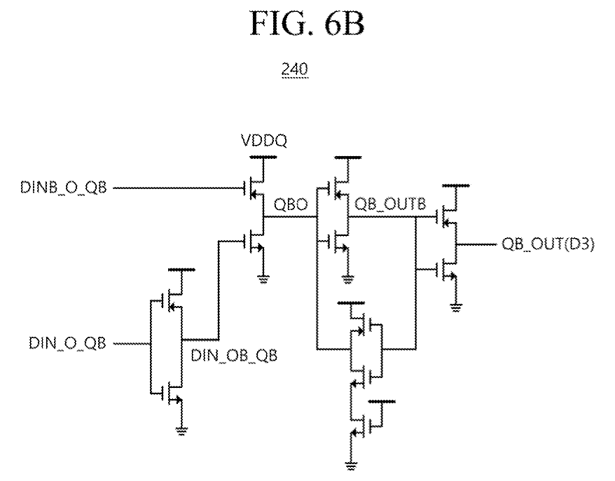

FIG. 6A is a circuit diagram of a decision feedback equalization block according to one or more embodiments. A decision feedback equalization block 140 of FIG. 6A may correspond to the fourth decision feedback equalization block 140 of FIG. 2.

Referring to FIG. 6A, the fourth decision feedback equalization block 140 may include a fourth input stage 141 and a fourth latching stage 142.

The fourth input stage 141 may include a fourth input circuitry 141-1 and fourth tap circuitries 141-2 and 141-3.

The fourth input circuitry 141-1 may receive a reference voltage VREF, a data signal DQ, and a fourth clock signal WCK_QB.

The fourth input circuitry 141-1 may compare the reference voltage VREF and the data signal DQ based on the fourth clock signal WCK_QB to generate a seventh feedback signal F3 and an eighth feedback signal FB3. The fourth input circuitry 141-1 may apply a high-frequency gain to a difference between the voltage of the reference voltage VREF and the data signal DQ using the fourth source degeneration circuit 190-4. Accordingly, when the difference between the voltage of the data signal DQ and the reference voltage VREF includes a relatively high proportion of high-frequency components, a difference between the seventh feedback signal F3 and the eighth feedback signal FB3 may increase.

The fourth input circuitry 141-1 may have the same configuration as the first input circuitry 111-1. However, the only difference is that the fourth clock signal WCK_QB is applied to the gate terminals of the first PMOS transistor M1, the second PMOS transistor M2, the first NMOS transistor M5, and the second NMOS transistor M6, so that redundant descriptions are omitted.

The fourth tap circuitries 141-2 and 141-3 may receive fifth feedback signal F2 and the sixth feedback signal FB2 generated by the third decision feedback equalization block 130 and the tap coefficients W0B, W1B, and W2B.

The fourth tap circuitries 141-2 and 141-3 may apply weights to the seventh feedback signal F3 and the eighth feedback signal FB3 based on the fifth feedback signal F2 and the sixth feedback signal FB2 and the tap coefficients W0B, W1B, and W2B. Accordingly, a difference between the seventh feedback signal F3 and the eighth feedback signal FB3 may increase.

To this end, according to one or more embodiments, the fourth tap circuitries 141-2 and 141-3 may include a seventh tap circuit 141-2 applying a weight to the seventh feedback signal F3 based on the fifth feedback signal F2 and the tap coefficients W0B, W1B, and W2B. In addition, the fourth tap circuitries 141-2 and 141-3 may include an eighth tap circuit 141-3 applying a weight to the eighth feedback signal FB3 based on the sixth feedback signal FB2 and the tap coefficients W0B, W1B, and W2B.

As described above, the difference between the seventh feedback signal F3 and the eighth feedback signal FB3 may be determined based on the difference between the reference voltage VREF and a voltage of the data signal DQ, the tap coefficients W0B, W1B, and W2B, and the high-frequency gain applied by the fourth source degeneration circuit 190-4.

The fourth latching stage 142 may latch the difference between the seventh feedback signal F3 and the eighth feedback signal FB3 to generate a seventh output signal DIN_O_QB and an eighth output signal DINB_O_QB.

FIG. 6B is a circuit diagram of a latch block according to one or more embodiments. A latch block 240 of FIG. 6B may correspond to the fourth latch block 240 of FIG. 2.

Referring to FIG. 6B, the fourth latch block 240 may output fourth data D3 included in the data signal DQ based on the seventh and eighth output signals DIN_O_QB and DINB_O_QB generated by the fourth latching stage 142. The output signal QB_OUT of the fourth latch block 240 may correspond to the fourth data D3.

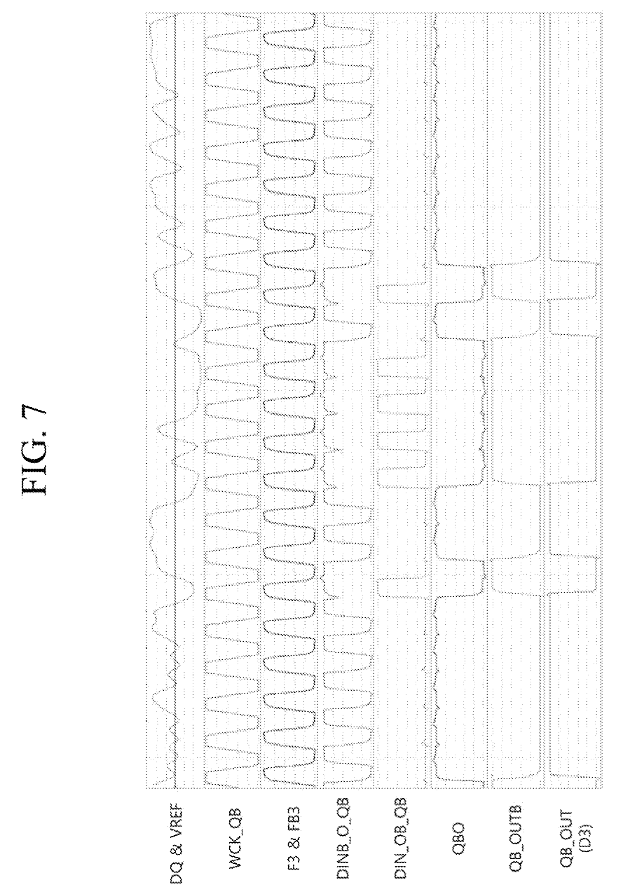

FIG. 7 is a timing diagram illustrating signals of a decision feedback equalization block and a latch block according to one embodiment. FIG. 7 illustrates signals of the fourth decision feedback equalization block 140 and the fourth latch block 240 as representative examples.

Referring to FIG. 6A, FIG. 6B, and FIG. 7, the data signal DQ transmitted from a host may be degraded due to noise, such as inter-symbol interference (ISI), when the data signal DQ is received at the data pad 11 through a transmission line (or a channel), resulting in a waveform as illustrated in FIG. 7.

The fourth input stage 141 of the fourth decision feedback equalization block 140 may compare the reference voltage VREF and the data signal DQ based on the fourth clock signal WCK_QB to generate a seventh feedback signal F3 and an eighth feedback signal FB3.

The fourth input stage 141 may increase or amplify a difference between the seventh feedback signal F3 and the eighth feedback signal FB3 using the fourth tap circuitries 141-2 and 141-3. In addition, the fourth input stage 141 may further increase the difference between the seventh feedback signal F3 and the eighth feedback signal FB3 using the fourth source degeneration circuit 190-4.

Due to limitations in illustration, in FIG. 7, the seventh feedback signal F3 and the eighth feedback signal FB3 are illustrated as if they are a single signal. However, in practice, a measurable difference exists between the seventh feedback signal F3 and the eighth feedback signal FB3.

For example, the seventh feedback signal F3 and the eighth feedback signal FB3 may exhibit a difference (e.g., a phase difference or a magnitude difference at the same time point) in each cycle depending on a voltage difference between the reference voltage VREF and the data signal DQ. In addition, the difference between the seventh feedback signal F3 and the eighth feedback signal FB3 may be increased by the tap coefficients W0B, W1B, and W2B or the high-frequency gain applied by the fourth source degeneration circuit 190-4.

The fourth latching stage 142 of the fourth decision feedback equalization block 140 may latch the difference between the seventh feedback signal F3 and the eighth feedback signal FB3 to generate a seventh output signal DIN_O_QB and an eighth output signal DINB_O_QB.

The fourth latch block 240 may output the output signal QB_OUT based on the seventh output signal DIN_O_QB and the eighth output signal DINB_O_QB. The fourth latch block 240 may invert the seventh output signal DIN_O_QB and generate the output signal QB_OUT based on an inverted version of the seventh signal DIN_OB_QB and the eighth output signal DINB_O_QB. In FIG. 7, QBO and QB_OUTB represent signals at the QBO node and the QB_OUTB node of the fourth latch block 240, respectively.

FIG. 7 illustrates driving signals of the fourth decision feedback equalization block 140 and the fourth latch block 240 as representative examples. Driving signals of the remaining decision feedback equalization blocks 110, 120, and 130 and latch blocks 210, 220, and 230 may be similar to the illustrated examples.

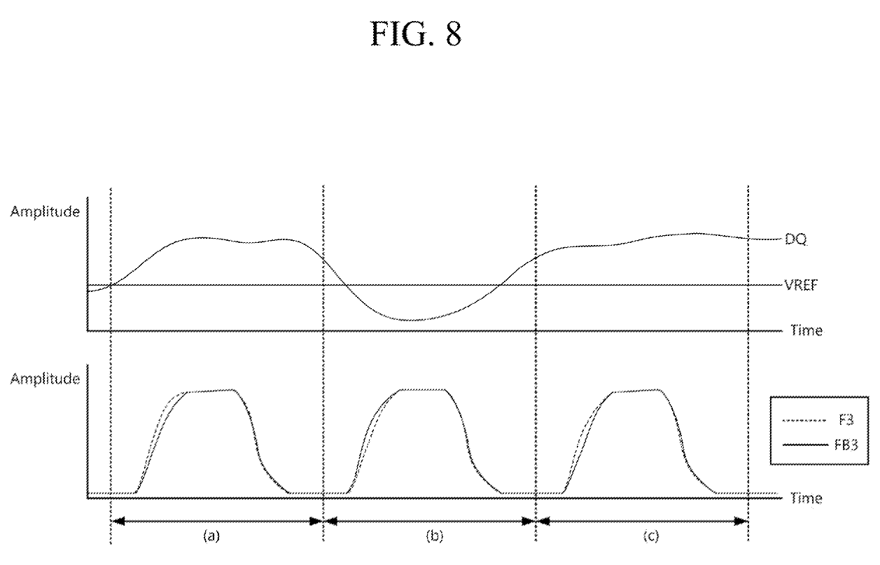

FIG. 8 is an exemplary diagram illustrating, in greater detail, a portion of driving signals of a decision feedback equalization block according to one or more embodiments. FIG. 8 illustrates signals of the fourth decision feedback equalization block 140 as representative examples.

Referring to FIG. 8, in intervals in which a data signal DQ is higher than a reference voltage VREF (e.g., intervals (a) and (c)), a phase of the seventh feedback signal F3 may lead a phase of the eighth feedback signal FB3. In intervals in which the data signal DQ is lower than the reference voltage VREF (for example, interval (b)), a phase of the eighth feedback signal FB3 may lead a phase of the seventh feedback signal F3. The same applies to the other decision feedback equalization blocks 110, 120, and 130.

As described above, a difference between two feedback signals generated by a decision feedback equalization block may vary depending on ta voltage difference between the reference voltage VREF and the data signal DQ.

In an interval in which the data signal DQ changes in the order of high, low, high within a predetermined time (e.g., interval (b)), a difference between the voltage of the data signal DQ and the reference voltage VREF may include a relatively high proportion of high-frequency components, compared to interval (a) or (c). The predetermined time may be, for example, 1 unit interval (UI), but embodiments are not limited thereto. In interval (b), the fourth source degeneration circuit 190-4 may apply a significant high-frequency gain to the difference between the voltage of the data signal DQ and the reference voltage VREF. Therefore, according to embodiments, a difference between the seventh feedback signal F3 and the eighth feedback signal FB3 may increase in interval (b), compared to the case in which the fourth source degeneration circuit 190-4 is absent. The same applies to the other decision feedback equalization blocks 110, 120, and 130.

As described above, a difference between two feedback signals generated by a decision feedback equalization block may vary depending on the presence or absence of the source degeneration circuit 190.

Interval (b) has been described as an example in which a significant high-frequency gain is applied by the source degeneration circuit 190, but embodiments are not limited thereto. For example, a significant high-frequency gain may also be applied by the source degeneration circuit 190 when the data signal DQ changes in the order of low, high, low within a predetermined time.

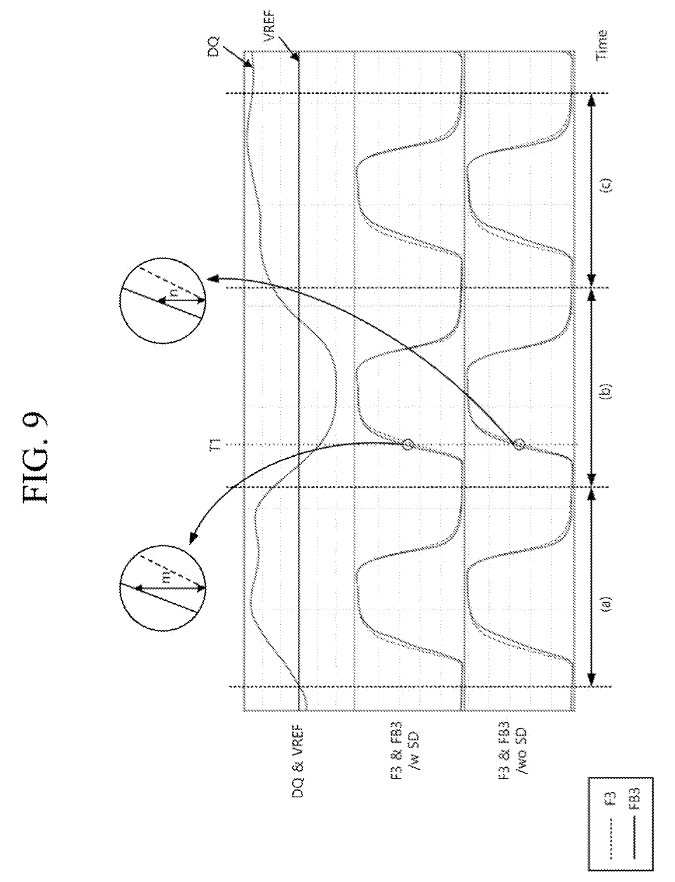

FIG. 9 is a diagram illustrating the effect of a source degeneration circuit according to one or more embodiments.

In FIG. 9, F3 & FB3 /w SD represents the seventh feedback signal F3 and the eighth feedback signal FB3 when the fourth decision feedback equalization block 140 includes the fourth source degeneration circuit 190-4, and F3 & FB3 /wo SD represents the seventh feedback signal F3 and the eighth feedback signals FB3 when the fourth decision feedback equalization block 140 does not include the fourth source degeneration circuit 190-4. Intervals (a), (b), and (c) of FIG. 9 may correspond to intervals (a), (b), and (c) of FIG. 8, respectively.

In FIG. 9, m represents the difference between the seventh feedback signal F3 and the eighth feedback signal FB3 at time point T1 when the fourth decision feedback equalization block 140 includes the fourth source degeneration circuit 190-4. In addition, n represents the difference between the seventh feedback signal F3 and the eighth feedback signal FB3 at time point T1 when the fourth decision feedback equalization block 140 does not include the fourth source degeneration circuit 190-4.

Referring to FIG. 9, m is greater than n. For example, when the fourth decision feedback equalization block 140 includes the fourth source degeneration circuit 190-4, the difference between the seventh feedback signal F3 and the eighth feedback signal FB3 in interval (b) may be relatively larger. A greater difference between the seventh feedback signal F3 and the eighth feedback signal FB3 allows the fourth latching stage 142 to more accurately latch the signal. Specifically, the larger the difference between the seventh feedback signal F3 and the eighth feedback signal FB3, the more accurately the fourth latching stage 142 may latch the difference. The same applies to the other decision feedback equalization blocks 110, 120, and 130. As described above, incorporating the source degeneration circuit 190 into the decision feedback equalizer 100 may improve the performance of the decision feedback equalizer 100.

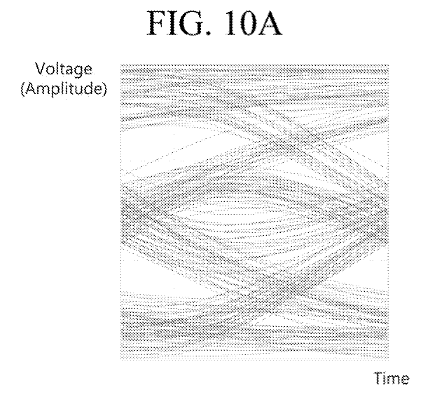

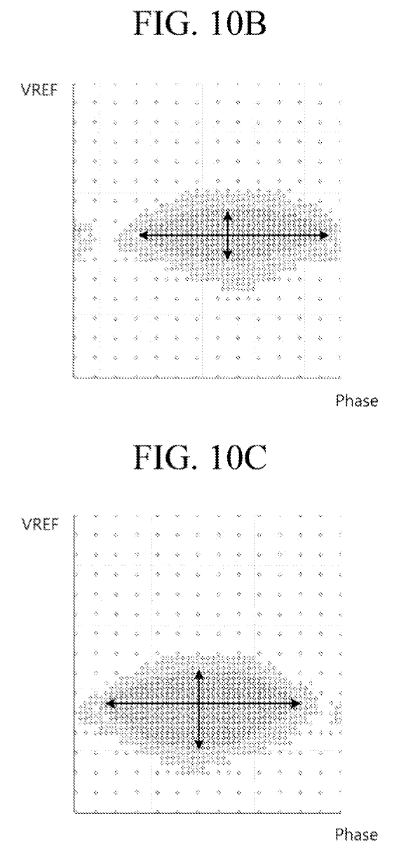

Hereinafter, the effects of the decision feedback equalizer according to embodiments will be described with reference to FIGS. 10A-10C.

FIG. 10A is an eye diagram of the data signal DQ measured at the data pad 11 of the memory device 10. Referring to FIG. 10A, the eye may close as illustrated due to inter-symbol interference (ISI) or similar effects at high data rates (e.g., 20 Gb/s or higher).

FIG. 10B and FIG. 10C represent shmoo plots illustrating results of testing the reception performance of the memory device 10 using a decision feedback equalizer under the same conditions as in FIG. 10A. In each of the shmoo plots, the x-axis represents a phase of a clock signal applied to the decision feedback equalizer, the y-axis represents a reference voltage VREF, and a region marked with an arrow corresponds to a passing region.

FIG. 10B illustrates the case in which a decision feedback equalizer without the source degeneration circuit 190 is used, while FIG. 10C illustrates the case in which a decision feedback equalizer 100 including the source degeneration circuit 190 is used. As shown in FIGS. 10B and 10C, the decision feedback equalizer 100 including the source degeneration circuit 190 exhibits improved performance.

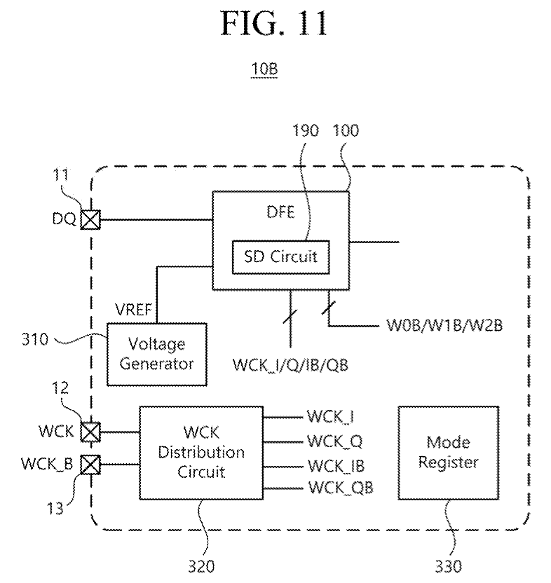

FIG. 11 is a block diagram of a memory device according to one or more embodiments. A memory device 10B of FIG. 11 may be an example of the memory device 10 of FIG. 1 or the memory device 10A of FIG. 2. In the description referring to FIG. 11, redundant details are omitted or simplified.

Referring to FIG. 11, the memory device 10B may include a data pad 11, a first clock pad 12, a second clock pad 13, a decision feedback equalizer 100, a voltage generator 310, a write clock distribution circuit 320, and a mode register 330.

The voltage generator 310 may generate various voltages required for the operation of the memory device 10B. For example, the voltage generator 310 may generate a reference voltage VREF. For example, the voltage generator 310 may generate the reference voltage VREF based on various power supply voltages (e.g., VDD, VDDQ, or the like) applied through a power supply voltage pad (or a power supply voltage pin). The generated reference voltage VREF may be provided to the decision feedback equalizer 100.

The write clock distribution circuit 320 may generate a plurality of clock signals WCK_I, WCK_Q, WCK_IB, and WCK_QB having different phases and provide the generated plurality of clock signals WCK_I, WCK_Q, WCK_IB, and WCK_QB to the decision feedback equalizer 100.

For example, the write clock distribution circuit 320 may receive a first write clock signal WCK and a second write clock signal WCK_B through the first clock pad 12 and the second clock pad 13, respectively. The first write clock signal WCK and the second write clock signal WCK_B may have opposite phases. In addition, the write clock distribution circuit 320 may generate the plurality of clock signals WCK_I, WCK_Q, WCK_IB, and WCK_QB based on the first write clock signal WCK and the second write clock signal WCK_B. To this end, the write clock distribution circuit 320 may include a 4-phase frequency divider, a phase-locked loop PLL, or the like, but embodiments are not limited thereto. The generated plurality of clock signals WCK_I, WCK_Q, WCK_IB, and WCK_QB may be provided to the decision feedback equalizer 100.

An example has been described, where the decision feedback equalizer 100 includes four decision feedback equalization blocks 110, 120, 130, and 140 and the write clock distribution circuit 320 generates and provides four divided clock signals WCK_I, WCK_Q, WCK_IB, and WCK_QB to the four decision feedback equalization blocks 110, 120, 130, and 140, respectively. However, embodiments are not limited thereto. According to one or more embodiments, the number of decision feedback equalization blocks included in the decision feedback equalizer 100 may vary. The number of clock signals generated by the write clock distribution circuit 320 and the phase relationships between the clock signals may vary.

The mode register 330 may store values of tap coefficients W0B, W1B, and W2B. For example, a single tap coefficient set, selected from various tap coefficient sets based on combinations of tap coefficient values, may be set in the mode register 330. The tap coefficients W0B, W1B, and W2B set in the mode register 330 may be provided to tap circuits 111-2, 111-3, 121-2, 121-3, 131-2, 131-3, 141-2, and 141-3.

For example, the memory device 10B may change a set value of the mode register 330 based on a mode register write command received from a host. Alternatively, the memory device 10B may change a set value of the mode register 330 based on a mode register write command received from test equipment in a test mode register set (TMRS) mode. The TMRS mode may refer to a type of test mode for testing a memory module and/or a memory device.

An example has been described where three tap coefficients W0B, W1B, and W2B are provided, but embodiments are not limited thereto. Two or four or more tap coefficients may be used according to one or more embodiments. Therefore, the tap circuits 111-2, 111-3, 121-2, 121-3, 131-2, 131-3, 141-2, and 141-3 may be modified.

According to one or more embodiments, the memory device 10B may include I/O circuits related to data input/output. The I/O circuits may include input path circuits and output path circuits, and the decision feedback equalizer 100 may be included in the input path circuits. The decision feedback equalizer 100 may be directly connected to the data pad 11. For example, as described above, the decision feedback equalizer 100 includes the source degeneration circuit 190, and additional circuit configuration, such as a continuous time linear equalization (CTLE) circuit, may be omitted between the data pad 11 and the decision feedback equalizer 100.

In one or more embodiments of the present disclosure, a semiconductor device may include: a data pad; and a decision feedback equalizer configured to equalize a data signal received through the data pad. The decision feedback equalizer may include a plurality of decision feedback equalization blocks, respectively corresponding to a plurality of clock signals having different phases. Each of the plurality of decision feedback equalization blocks may include: an input stage configured to compare a reference voltage with the data signal based on a corresponding clock signal, and amplify a difference between the reference voltage and a voltage of the data signal, and generate a first feedback signal and a second feedback signal based on the amplified difference between the reference voltage and the voltage of the data signal; and a latching stage configured to generate a first output signal and a second output signal based on a difference between the first feedback signal and the second feedback signal.

The input stage may include: input circuitry configured to receive the reference voltage, the data signal, and the corresponding clock signal; and tap circuitry configured to receive a third feedback signal and a fourth feedback signal, generated by another decision feedback equalization block among the plurality of decision feedback equalization blocks, and tap coefficients; and the input circuitry may include a source degeneration circuit configured to amplify the difference between the reference voltage and the voltage of the data signal.

The source degeneration circuit may be configured to apply a gain in a predetermined frequency band greater than a threshold frequency, to the difference between the reference voltage and the voltage of the data signal.

The difference between the first feedback signal and the second feedback signal may be determined based on the difference between the reference voltage and the voltage of the data signal, the tap coefficients, and the gain applied by the source degeneration circuit.

The input circuitry may include: a first PMOS transistor including a drain terminal connected to a power supply voltage, a source terminal connected to one end of the source degeneration circuit, and a gate terminal to which the corresponding clock signal is applied; a second PMOS transistor including a drain terminal connected to a power supply voltage, a source terminal connected to another end of the source degeneration circuit, and a gate terminal to which the corresponding clock signal may be applied; a third PMOS transistor including a drain terminal connected to the one end of the source degeneration circuit, a source terminal generating the second feedback signal, and a gate terminal to which the data signal may be applied; a fourth PMOS transistor including a drain terminal connected to the another end of the source degeneration circuit, a source terminal generating the first feedback signal, and a gate terminal to which the reference voltage is applied; a first NMOS transistor including a drain terminal connected to the source terminal of the third PMOS transistor, a source terminal connected to a ground voltage, and a gate terminal to which the corresponding clock signal is applied; and a second NMOS transistor including a drain terminal connected to the source terminal of the fourth PMOS transistor, a source terminal connected to a ground voltage, and a gate terminal to which the corresponding clock signal may be applied.

The source degeneration circuit may include: a capacitor, or a resistor and the capacitor that may be connected in parallel.

The tap circuitry may include: a first tap circuit configured to apply a first weight to the first feedback signal based on the third feedback signal and the tap coefficients; and a second tap circuit configured to apply a second weight to the second feedback signal based on the fourth feedback signal and the tap coefficients.

The semiconductor device may include: a mode register configured to set the tap coefficients.

The plurality of clock signals may include: a first clock signal, a second clock signal that may be phase-shifted by 90 degrees relative to the first clock signal, a third clock signal that may be phase-shifted by 180 degrees relative to the first clock signal, and a fourth clock signal that may be phase-shifted by 270 degrees relative to the first clock signal; and the decision feedback equalizer may include: a first decision feedback equalization block corresponding to the first clock signal, a second decision feedback equalization block corresponding to the second clock signal, a third decision feedback equalization block corresponding to the third clock signal, and a fourth decision feedback equalization block corresponding to the fourth clock signal.

The first feedback signal and the second feedback signal generated by the input stage of the first decision feedback equalization block may be fed back to the input stage of the second decision feedback equalization block; the first feedback signal and the second feedback signal generated by the input stage of the second decision feedback equalization block may be fed back to the input stage of the third decision feedback equalization block; the first feedback signal and the second feedback signal generated by the input stage of the third decision feedback equalization block may be fed back to the input stage of the fourth decision feedback equalization block; and the first feedback signal and the second feedback signal generated by the input stage of the fourth decision feedback equalization block may be fed back to the input stage of the first decision feedback equalization block.

The semiconductor device may include: a first clock pad configured to receive a first write clock signal; a second clock pad configured to receive a second write clock signal having a phase opposite to a phase of the first write clock signal; and a clock distribution circuit configured to generate the first to fourth clock signals based on the first write clock signal and the second write clock signal and provide the first to fourth clock signals to the first to fourth decision feedback equalization blocks, respectively.

The decision feedback equalizer may be directly connected to the data pad.

The semiconductor device may include: a plurality of latch blocks, respectively corresponding to the plurality of decision feedback equalization blocks. Each of the plurality of latch blocks may be configured to output data based on the first output signal and the second output signal that may be output from a corresponding decision feedback equalization block.

In one or more embodiments of the present disclosure, a decision feedback equalizer may include: a first decision feedback equalization block configured to operate based on a first clock signal; a second decision feedback equalization block configured to operate based on a second clock signal that is phase-shifted by 90 degrees relative to the first clock signal; a third decision feedback equalization block configured to operate based on a third clock signal that is phase-shifted by 180 degrees relative to the first clock signal; and a fourth decision feedback equalization block configured to operate based on a fourth clock signal that may be phase-shifted by 270 degrees relative to the first clock signal. Each of the first to fourth decision feedback equalization blocks may include: an input stage configured to compare a reference voltage with a data signal based on a corresponding clock signal, amplify a difference between the reference voltage and the data signal, and generate a first feedback signal and a second feedback signal based on the amplified difference between the reference voltage and the data signal; and a latching stage configured to generate a first output signal and a second output signal based on a difference between the first feedback signal and the second feedback signal.

The input stage of the first decision feedback equalization block may include: first input circuitry configured to receive the reference voltage, the data signal, and the first clock signal; and first tap circuitry configured to receive a first feedback signal and a second feedback signal that may be generated by the fourth decision feedback equalization block, and tap coefficients. The input stage of the second decision feedback equalization block may include: second input circuitry configured to receive the reference voltage, the data signal, and the second clock signal; and second tap circuitry configured to receive a first feedback signal and a second feedback signal that may be generated by the first decision feedback equalization block, and the tap coefficients. The input stage of the third decision feedback equalization block may include: third input circuitry configured to receive the reference voltage, the data signal, and the third clock signal; and third tap circuitry configured to receive a first feedback signal and a second feedback signal that may be generated by the second decision feedback equalization block, and the tap coefficients. The input stage of the fourth decision feedback equalization block may include: fourth input circuitry configured to receive the reference voltage, the data signal, and the fourth clock signal; and fourth tap circuitry configured to receive a first feedback signal and a second feedback signal that may be generated by the third decision feedback equalization block, and the tap coefficients.

Each of the first to fourth input circuits may include a source degeneration circuit configured to amplify the difference between the reference voltage and the data signal by applying a gain in a predetermined frequency band greater than a threshold frequency, to the difference between the reference voltage and a voltage of the data signal.

The difference between the first feedback signal and the second feedback signal generated in each of the first to fourth decision feedback equalization blocks may be determined based on the difference between the reference voltage and the voltage of the data signal, the tap coefficients, and the gain applied by the source degeneration circuit.

The source degeneration circuit may include a capacitor, or a resistor and the capacitor that may be connected in parallel.

In one or more embodiments of the present disclosure, a decision feedback equalizer may include: an input stage configured to compare a reference voltage with a data signal based on a first clock signal and generate a first feedback signal and a second feedback signal based on a comparison between the reference voltage and the data signal; and a latching stage configured to latch a difference between the first feedback signal and the second feedback signal and generate a first output signal and a second output signal. The input stage may include a source degeneration circuit configured to apply a gain in a predetermined frequency band greater than a threshold frequency, to a difference between the reference voltage and a voltage of the data signal.

The input stage may include: input circuitry configured to receive the reference voltage, the data signal, and the first clock signal; and tap circuitry configured to receive a first feedback signal and a second feedback signal that are generated by another decision feedback equalizer operating based on a second clock signal, and tap coefficients. The difference between the first feedback signal and the second feedback signal is determined based on the difference between the reference voltage and the voltage of the data signal, the tap coefficients, and the high-frequency gain applied by the source degeneration circuit.

As set forth above, according to embodiments, a decision feedback equalizer with improved performance and a memory device including the same may be provided.

While various embodiments have been shown and described above, it will be apparent to those skilled in the art that modifications and variations could be made without departing from the scope of the present inventive concept as defined by the appended claims.

What is claimed is:

1. A semiconductor device comprising:
a data pad; and
a decision feedback equalizer configured to equalize a data signal received through the data pad,
wherein:
the decision feedback equalizer comprises a plurality of decision feedback equalization blocks, respectively corresponding to a plurality of clock signals having different phases;
each of the plurality of decision feedback equalization blocks comprises:
an input stage configured to compare a reference voltage with the data signal based on a corresponding clock signal, and amplify a difference between the reference voltage and a voltage of the data signal, and generate a first feedback signal and a second feedback signal based on the amplified difference between the reference voltage and the voltage of the data signal; and
a latching stage configured to generate a first output signal and a second output signal based on a difference between the first feedback signal and the second feedback signal.

2. The semiconductor device of claim 1, wherein:
the input stage comprises:
input circuitry configured to receive the reference voltage, the data signal, and the corresponding clock signal; and
tap circuitry configured to receive a third feedback signal and a fourth feedback signal, generated by another decision feedback equalization block among the plurality of decision feedback equalization blocks, and tap coefficients; and
the input circuitry comprises a source degeneration circuit configured to amplify the difference between the reference voltage and the voltage of the data signal.

3. The semiconductor device of claim 2, wherein:
the source degeneration circuit is configured to apply a gain in a predetermined frequency band greater than a threshold frequency, to the difference between the reference voltage and the voltage of the data signal.

4. The semiconductor device of claim 3, wherein:
the difference between the first feedback signal and the second feedback signal is determined based on the difference between the reference voltage and the voltage of the data signal, the tap coefficients, and the gain applied by the source degeneration circuit.

5. The semiconductor device of claim 2, wherein the input circuitry comprises:
a first PMOS transistor comprising a drain terminal connected to a power supply voltage, a source terminal connected to one end of the source degeneration circuit, and a gate terminal to which the corresponding clock signal is applied;
a second PMOS transistor comprising a drain terminal connected to a power supply voltage, a source terminal connected to another end of the source degeneration circuit, and a gate terminal to which the corresponding clock signal is applied;
a third PMOS transistor comprising a drain terminal connected to the one end of the source degeneration circuit, a source terminal generating the second feedback signal, and a gate terminal to which the data signal is applied;
a fourth PMOS transistor comprising a drain terminal connected to the another end of the source degeneration circuit, a source terminal generating the first feedback signal, and a gate terminal to which the reference voltage is applied;
a first NMOS transistor comprising a drain terminal connected to the source terminal of the third PMOS transistor, a source terminal connected to a ground voltage, and a gate terminal to which the corresponding clock signal is applied; and
a second NMOS transistor comprising a drain terminal connected to the source terminal of the fourth PMOS transistor, a source terminal connected to a ground voltage, and a gate terminal to which the corresponding clock signal is applied.

6. The semiconductor device of claim 5, wherein the source degeneration circuit comprises:
a capacitor, or a resistor and the capacitor that are connected in parallel.

7. The semiconductor device of claim 2, wherein the tap circuitry comprises:
a first tap circuit configured to apply a first weight to the first feedback signal based on the third feedback signal and the tap coefficients; and
a second tap circuit configured to apply a second weight to the second feedback signal based on the fourth feedback signal and the tap coefficients.

8. The semiconductor device of claim 2, comprising:
a mode register configured to set the tap coefficients.

9. The semiconductor device of claim 1, wherein:
the plurality of clock signals comprise:
a first clock signal, a second clock signal that is phase-shifted by 90 degrees relative to the first clock signal, a third clock signal that is phase-shifted by 180 degrees relative to the first clock signal, and a fourth clock signal that is phase-shifted by 270 degrees relative to the first clock signal; and
the decision feedback equalizer comprises:
a first decision feedback equalization block corresponding to the first clock signal, a second decision feedback equalization block corresponding to the second clock signal, a third decision feedback equalization block corresponding to the third clock signal, and a fourth decision feedback equalization block corresponding to the fourth clock signal.

10. The semiconductor device of claim 9, wherein:
the first feedback signal and the second feedback signal generated by the input stage of the first decision feedback equalization block are fed back to the input stage of the second decision feedback equalization block;
the first feedback signal and the second feedback signal generated by the input stage of the second decision feedback equalization block are fed back to the input stage of the third decision feedback equalization block;
the first feedback signal and the second feedback signal generated by the input stage of the third decision feedback equalization block are fed back to the input stage of the fourth decision feedback equalization block; and
the first feedback signal and the second feedback signal generated by the input stage of the fourth decision feedback equalization block are fed back to the input stage of the first decision feedback equalization block.

11. The semiconductor device of claim 9, comprising:
a first clock pad configured to receive a first write clock signal;
a second clock pad configured to receive a second write clock signal having a phase opposite to a phase of the first write clock signal; and
a clock distribution circuit configured to generate the first to fourth clock signals based on the first write clock signal and the second write clock signal and provide the first to fourth clock signals to the first to fourth decision feedback equalization blocks, respectively.

12. The semiconductor device of claim 1, wherein:
the decision feedback equalizer is directly connected to the data pad.

13. The semiconductor device of claim 1, further comprising:
a plurality of latch blocks, respectively corresponding to the plurality of decision feedback equalization blocks,
wherein:
each of the plurality of latch blocks is configured to output data based on the first output signal and the second output signal that are output from a corresponding decision feedback equalization block.

14. A decision feedback equalizer comprising:
a first decision feedback equalization block configured to operate based on a first clock signal;
a second decision feedback equalization block configured to operate based on a second clock signal that is phase-shifted by 90 degrees relative to the first clock signal;
a third decision feedback equalization block configured to operate based on a third clock signal that is phase-shifted by 180 degrees relative to the first clock signal; and
a fourth decision feedback equalization block configured to operate based on a fourth clock signal that is phase-shifted by 270 degrees relative to the first clock signal,
wherein:
each of the first to fourth decision feedback equalization blocks comprises:
an input stage configured to compare a reference voltage with a data signal based on a corresponding clock signal, amplify a difference between the reference voltage and the data signal, and generate a first feedback signal and a second feedback signal based on the amplified difference between the reference voltage and the data signal; and
a latching stage configured to generate a first output signal and a second output signal based on a difference between the first feedback signal and the second feedback signal.

15. The decision feedback equalizer of claim 14, wherein:
the input stage of the first decision feedback equalization block comprises:
first input circuitry configured to receive the reference voltage, the data signal, and the first clock signal; and
first tap circuitry configured to receive a first feedback signal and a second feedback signal that are generated by the fourth decision feedback equalization block, and tap coefficients;
the input stage of the second decision feedback equalization block comprises:
second input circuitry configured to receive the reference voltage, the data signal, and the second clock signal; and
second tap circuitry configured to receive a first feedback signal and a second feedback signal that are generated by the first decision feedback equalization block, and the tap coefficients;
the input stage of the third decision feedback equalization block comprises:
third input circuitry configured to receive the reference voltage, the data signal, and the third clock signal; and
third tap circuitry configured to receive a first feedback signal and a second feedback signal that are generated by the second decision feedback equalization block, and the tap coefficients; and
the input stage of the fourth decision feedback equalization block comprise:
fourth input circuitry configured to receive the reference voltage, the data signal, and the fourth clock signal; and
fourth tap circuitry configured to receive a first feedback signal and a second feedback signal that are generated by the third decision feedback equalization block, and the tap coefficients.

16. The decision feedback equalizer of claim 15, wherein:
each of the first to fourth input circuits comprises a source degeneration circuit configured to amplify the difference between the reference voltage and the data signal by applying a gain in a predetermined frequency band greater than a threshold frequency, to the difference between the reference voltage and a voltage of the data signal.

17. The decision feedback equalizer of claim 16, wherein:
the difference between the first feedback signal and the second feedback signal generated in each of the first to fourth decision feedback equalization blocks is determined based on the difference between the reference voltage and the voltage of the data signal, the tap coefficients, and the gain applied by the source degeneration circuit.

18. The decision feedback equalizer of claim 16, wherein:
the source degeneration circuit comprises a capacitor, or a resistor and the capacitor that are connected in parallel.

19. A decision feedback equalizer comprising:
an input stage configured to compare a reference voltage with a data signal based on a first clock signal and generate a first feedback signal and a second feedback signal based on a comparison between the reference voltage and the data signal; and
a latching stage configured to latch a difference between the first feedback signal and the second feedback signal and generate a first output signal and a second output signal,
wherein:
the input stage comprises a source degeneration circuit configured to apply a gain in a predetermined frequency band greater than a threshold frequency, to a difference between the reference voltage and a voltage of the data signal.

20. The decision feedback equalizer of claim 19, wherein:
the input stage comprises:
input circuitry configured to receive the reference voltage, the data signal, and the first clock signal; and
tap circuitry configured to receive a first feedback signal and a second feedback signal that are generated by another decision feedback equalizer operating based on a second clock signal, and tap coefficients; and
the difference between the first feedback signal and the second feedback signal is determined based on the difference between the reference voltage and the voltage of the data signal, the tap coefficients, and the high-frequency gain applied by the source degeneration circuit.
